(19) United States
(12) Patent Application Publication
(10) Pub. No.: US 2002/0105742 A1
(43) Pub. Date: Aug. 8, 2002

(54) Rear-view mirror for passenger car

(76) Inventors: Jun-Sung Jeon, Kyungki-do (KR); Dong-Ho Kang, Kyungki-Do (KR)

Correspondence Address: BURNS DOANE SWECKER & MATHIS L L P, POST OFFICE BOX 1404, ALEXANDRIA, VA, 22313-1404, US

(21) Appl. No.: 10/016,144

(22) Filed: Dec. 17, 2001

(30) Foreign Application Priority Data
Dec. 15, 2000 (KR) 2000-35195

(51) Int. Cl. A47G 1/16; A47F 7/14; G02B 7/182

(52) U.S. Cl. 359/871; 248/475.1

(57) ABSTRACT

A rear-view mirror to be equipped in a passenger car is provided, which comprises: a main body to be mounted at the rear end of trunk lead 30 by a pair of joint elements which are formed as being projected to provide a space between the main body and the said trunk lead 30; and a mirror for viewing the rear side of the said trunk lead 30, as being fitted in a inclined manner to the inside portion of center area of the said main body. The rear-view mirror of the invention to be equipped in a passenger car has the same shape of main body as an air spoiler, which can generate a downward force, thereby providing the safe driving of the passenger car, as well as promoting a recognition of whether a certain obstacle exist behind the car when backward driving, to provide an easy driving.

### BACKGROUND OF THE INVENTION

1.Field of the Invention

The present invention relates to a rear-view mirror to be equipped in a passenger car.

2.Description of the Related Art

In general, a configuration of the rear portion of automobile, especially a passenger car, may have a various shapes and formations, and particularly include a type of vertical wall and another type of “L” form when shown from their longitudinal section.

In case of a car having the rear portion of vertical wall type, since it generally has the rear view mirror, the driver can confirm whether there is any obstacle projected from the ground behind the car, when it goes backward.

In this case, the rear view mirror may usually be positioned at a position of the rear glass wall, in which the joint element is to be equipped at the top height of rear side of the car and the jointed main body has a convex mirror on one side faced to the driver's sight.

However, the said type of rear view mirror for the car having vertical wall at rear portion could not be useful for the other type of car having the rear portion of “L” shape longitudinal section.

Therefore, a driver of a car without the rear view mirror could not confirm precisely whether or not there is any obstacle behind the car, when it goes backward or park.

Accordingly, the present invention has been made in an effort to solve the aforementioned problems, and it is an object of the present invention to provide a rear view mirror by which the drivers can easily confirm precisely whether or not there is any obstacle behind the car, when it goes backward or park, even in a case of car having the rear portion of “L” shape longitudinal section.

### SUMMARY OF THE INVENTION

In accordance with one aspect, the present invention provides a rear-view mirror to be equipped in a passenger car, which comprises: a main body to be mounted at the rear end of trunk lead 30 by a pair of joint elements which are formed as being projected to provide a space between the main body and the said trunk lead 30; and a mirror 20 for viewing the rear side of the said trunk lead 30, as being inclined to fit to the inside portion of center area of the said main body.

### BRIEF DESCRIPTION OF THE DRAWINGS

The above objects, and other features and advantages of the present invention will become more apparent after a reading of the following detailed description when taken in conjunction with the drawings, in which:

FIG. 1 is a perspective view for showing the rear-view mirror according to the first embodiment of the invention;

FIG. 2 is a perspective view for showing the rear-view mirror according to FIG. 1 as being equipped to the car;

FIG. 3 is a perspective view for showing the rear-view mirror according the second embodiment of the invention;

FIG. 4 is a perspective view for showing the rear-view mirror according to the third embodiment of the invention; and

FIG. 5 is a perspective view for showing the rear-view mirror according to FIG. 3 as being equipped to the car.

### DETAILED DESCRIPTION OF PREFERRED EMBODIMENTS

A preferable embodiment according to the present invention will be apparent from the following description along with the accompanying drawings.

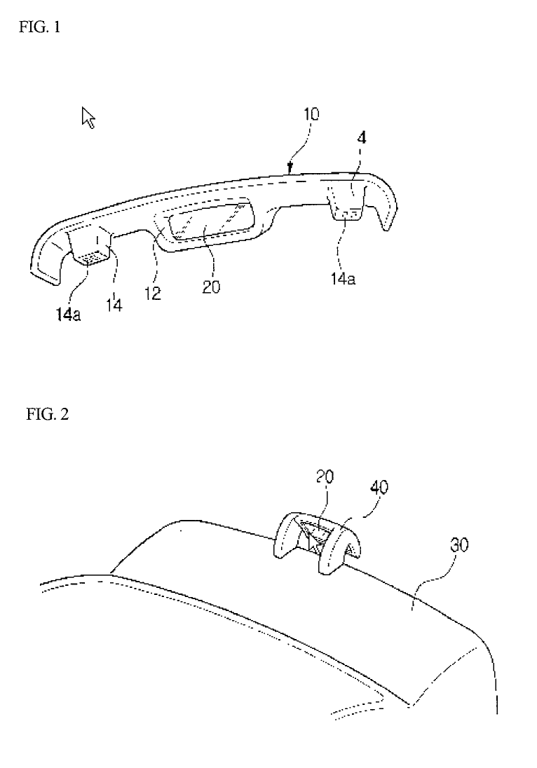

FIG. 1 is a perspective view for showing the rear-view mirror according to the first embodiment of the invention, and FIG. 2 is a perspective view for showing the rear-view mirror according to FIG. 1 as being equipped to the car.

As shown in FIG. 1 and FIG. 2, the rear-view mirror according to the present invention comprises a main body 10 jointed with the trunk lead 30 of the car, and a mirror 20 attached to the said main body 10.

The main body 10 has a pair of joint portions 14 protruded beneath the main body 10, in order to have a space between the main body 10 and the surface of the said trunk lead 30. The main 10 body 10 having a pair of joint portions 14 is to be set at a point backward the trunk lead 30.

The length of main body 10 corresponds to the length of width of trunk lead 30, and its shape is same as or similar to the conventional air spoiler according to the prior art. Such spoiler has been used in a car, in order to generate a down force for canceling the force resulting from the difference of air-pressure between front and behind area of driving car, which may reduce the driving force of car.

The joint portion 14 comprises a joint hole 14a which is formed beneath the main body 10 and into which a joint element is inserted, and a joint element, such as volt, which connects the main body 10 to trunk lead 30 of car and provides supporter between them.

Moreover, the main body has a depressed area 12 formed inside its central region. At the depressed area 12 formed inside its central region, the mirror 20 is to be attached, which shows the scene backward the trunk lead 30. Thus, the mirror 20 can show the rear side of the said trunk lead 30, as being inclined to fit to the inside portion of center area of the said main body 10.

In a preferable embodiment according to the invention, a convex or planar mirror can be used for the rear view mirror 20, and it may be attached to and/or bonded with the depressed area 12 of main body 10, by using the adhesives to be applied to back of mirror, or forming a concave grove into the depressed area 12.

FIG. 2 is a perspective view for showing the rear-view mirror according to FIG. 1 as being equipped to the car. As shown in FIG. 2, when driving the car backward or parking, the driver can readily confirm the circumstance or environment backward by watching in room mirror or directly look back the rear view mirror.

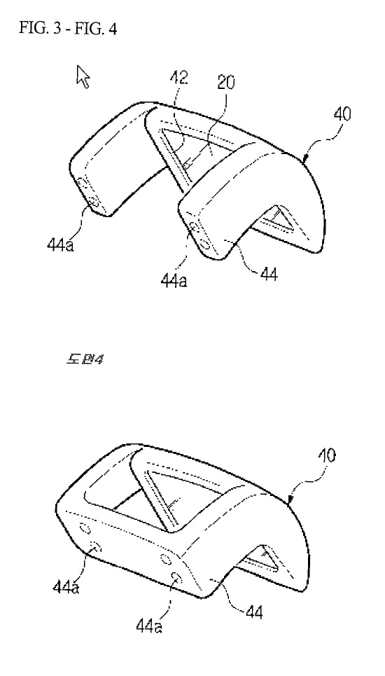

In the second embodiment of the present invention, as shown in FIG. 3, the rear view mirror comprises: a main body 40 to be mounted at the rear end of trunk lead 30 by a pair of joint portions 44 having each joint hole 44a to provide a joint between the main body 10 and the said trunk lead 30; and a mirror 20 for viewing the rear side of the said trunk lead 30, as being inclined to fit to the inside portion of center area of the said main body.

Likely to the first embodiment of the invention, the driver can also readily confirm the circumstance or environment backward by watching in room mirror or directly look back the rear view mirror.

Furthermore, in the third embodiment of the present invention, as shown in FIG. 4, a pair of joint portions 44 formed at left and right sides the mirror 40 can be formed in an integrated configuration in which the low edges may be unified.

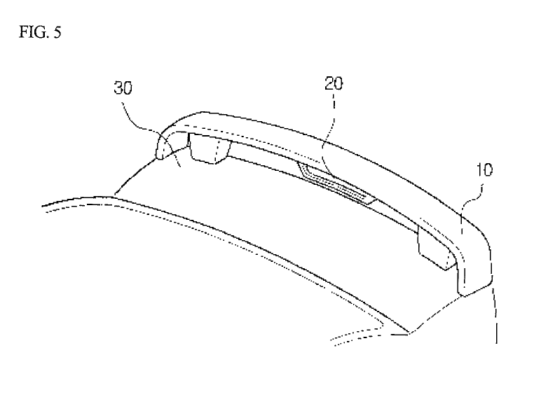

FIG. 5 is a perspective view for showing the rear-view mirror according to FIG. 3 as being equipped to the car. As shown in FIG. 5, the driver can also readily confirm the circumstance or environment backward by watching in room mirror or directly look back the rear view mirror.

As aforementioned hereto, since the rear view mirror according to the present invention has a aerodynamic type of main body such as air spoiler in the prior art, it can promote the safe driving during the road drive as well as a safe driving backward or parking, due to the possible recognition of any obstacles behind the car.

What is claimed is:

1. A rear-view mirror to be equipped in a passenger car, which comprises: a main body to be mounted at the rear end of trunk lead 30 by a pair of joint elements which are formed as being projected to provide a space between the main body and the said trunk lead 30; and a mirror 20 for viewing the rear side of the said trunk lead 30, as being inclined to fit to the inside portion of center area of the said main body.

2. The rear-view mirror as claimed in claim 1, wherein the length of the main body corresponds to the length of width of the said trunk lead 30, and a pair of joint elements formed on the said main body are positioned beneath the said main body, as being adjacent to the left/right ends of the said trunk lead 30.

3. The rear-view mirror as claimed in claim 1, wherein the main body comprises: a mirror 20 being attached in the inclined manner to the said main body for viewing the rear scene; and a pair of joint elements, each of which joints the said trunk lead 30 and the main body having the joint holes at its low end, each of which is positioned left and right sides of the mirror 20.
